(19) United States
(12) Patent Application Publication
(10) Pub. No.: US 2013/0073798 A1
(43) Pub. Date: Mar. 21, 2013

(54) FLASH MEMORY DEVICE AND DATA MANAGEMENT METHOD

(71) Applicants: NAM WOOK KANG, HWASEONG-SI (KR); DAWOON JUNG, HWASEONG-SI (KR)

(72) Inventors: NAM WOOK KANG, HWASEONG-SI (KR); DAWOON JUNG, HWASEONG-SI (KR)

(73) Assignee: SAMSUNG ELECTRONICS CO., LTD., SUWON-SI (KR)

(21) Appl. No.: 13/517,855

(22) Filed: Jun. 14, 2012

(30) Foreign Application Priority Data
Sep. 20, 2011 (KR) 10-2011-0094724

(51) Int. Cl. G06F 12/02

(52) U.S. Cl. 711/103; 711/E12.008

(57) ABSTRACT

Disclosed is a data management method for a flash storage device. The method includes collecting cold data stored in the flash memory device with reference to a cold list table, compressing the collected cold data, and then storing the compressed cold data in the flash memory.

### CROSS-REFERENCE TO RELATED APPLICATIONS

This application claims the benefits under 35 U.S.C §119 to Korean Patent Application No. 10-2011-0094724 filed Sep. 20, 2011, the subject matter of which is hereby incorporated by reference.

### BACKGROUND OF THE INVENTION

The present inventive concept relates to nonvolatile memory devices, including flash memory devices, and data management methods.

Semiconductor memory devices include volatile memories, such as DRAM, SRAM and the like, and nonvolatile memories such as EEPROM, FRAM, PRAM, MRAM, flash memory, and the like. Volatile memory loses stored data in the absence of applied power. In contrast, nonvolatile memory retains stored data in the absence of applied power.

The number and type of devices incorporating a nonvolatile memory continue to increase. For example, many contemporary MP3 players, digital cameras, cellular phones, flash cards, and Solid State Disks (SSDs) use at least one nonvolatile memory as a storage device. Among other types of nonvolatile memory, flash memory enjoys certain performance advantages. For example, flash memory is commonly configured to electrically erase a number of flash memory cells during a single erase operation. Flash memory is widely used as a storage device and in many applications has replaced the hard disk.

Flash memory is further characterized by its requirement to perform an erase operation prior to execution of a write operation. This requirement generally reduces the performance efficiency of the flash memory. As a user-demanded storage capacity increases, different data management methods are needed to facilitate the efficiently use of memory space within flash memory.

### SUMMARY

One aspect of embodiments of the inventive concept is directed to a data management method for a flash storage device including flash memory, the method comprising; creating a cold list table identifying cold data stored in the flash memory, collecting a set of the cold data in a volatile memory by referencing the cold list table to generate a cold data set, and then compressing the cold data set to generate a compressed cold data set, and thereafter, storing the compressed cold data set in the flash memory.

Another aspect of embodiments of the inventive concept is directed to a data management method for a flash storage device including flash memory and a work memory, the method comprising; upon power-up of the flash storage device, creating a cold list table storing a cold value for a data page stored in the flash memory, creating a compression data table storing compression rate information for the data page, and storing access information for the data page, in response to a received read request directed to the data page, updating the access information for the data page, updating the cold value for the data page in the cold list table, and performing the read operation, wherein the data page is compressed cold data previously stored in the flash memory after being collected in the work memory and compressed according to compression rate information, and performing the read operation comprises decompressing the page data in accordance with the compression rate information.

Another aspect of embodiments of the inventive concept is directed to a data management method for a flash storage device including flash memory and a work memory, the method comprising; upon power-up of the flash storage device, creating a cold list table storing a cold value for a data page stored in the flash memory, creating a compression data table storing compression rate information for the data page, and storing access information for the data page, in response to a received garbage collection request, detecting the data page as cold data stored in the flash memory with reference to the cold list table and collecting the data page in the work memory, compressing the data page to generate a compressed data page, and thereafter, storing the compressed data page in the flash memory.

### BRIEF DESCRIPTION OF THE DRAWINGS

The above and other objects and features will become apparent from the following description with reference to the following figures, wherein like reference numbers and labels are used to denote like or similar elements and features.

FIG. 1 is a block diagram schematically illustrating a memory system according to an embodiment of the inventive concept.

FIG. 2 is a block diagram schematically illustrating a flash memory system according to an embodiment of the inventive concept.

FIG. 3 is a flowchart summarizing a data management method for the flash memory system of FIG. 2.

FIGS. 4 through 7 are diagrams describing an update operation for a cold list table used in conjunction with the flash memory system of FIG. 2.

FIGS. 8 through 13 are diagrams describing a compressed garbage collection operation for the flash memory system of FIG. 2.

FIG. 14 is a diagram illustrating an embodiment of a compressed garbage collection operation for the flash memory system of FIG. 2.

FIG. 15 is a diagram illustrating an embodiment of a compressed garbage collection operation for the flash memory system of FIG. 2.

FIG. 16 is a diagram further describing operation of the compressor of FIG. 2.

FIG. 17 is a diagram illustrating a compressor according to an embodiment of the inventive concept.

FIG. 18 is a diagram illustrating a compressor according to another embodiment of the inventive concept.

FIG. 19 is a diagram illustrating a compressor according to still another embodiment of the inventive concept.

FIG. 20 is a flowchart summarizing an access operation of a flash memory device according to an embodiment of the inventive concept.

FIG. 21 is a block diagram schematically illustrating a flash memory system according to another embodiment of the inventive concept.

FIG. 22 is a block diagram illustrating a memory card system to which a flash memory system according to an embodiment of the inventive concept is applied.

FIG. 23 is a block diagram illustrating a solid state drive system including a storage system to which a compressed garbage collection technique according to an embodiment of the inventive concept is applied.

FIG. 24 is a block diagram schematically illustrating an SSD controller in FIG. 23.

FIG. 25 is a block diagram illustrating a flash memory module to which a compressed garbage collection operation according to an embodiment of the inventive concept is applied.

### DETAILED DESCRIPTION

The inventive concept will now be described in some additional detail with reference to the accompanying drawings. This inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

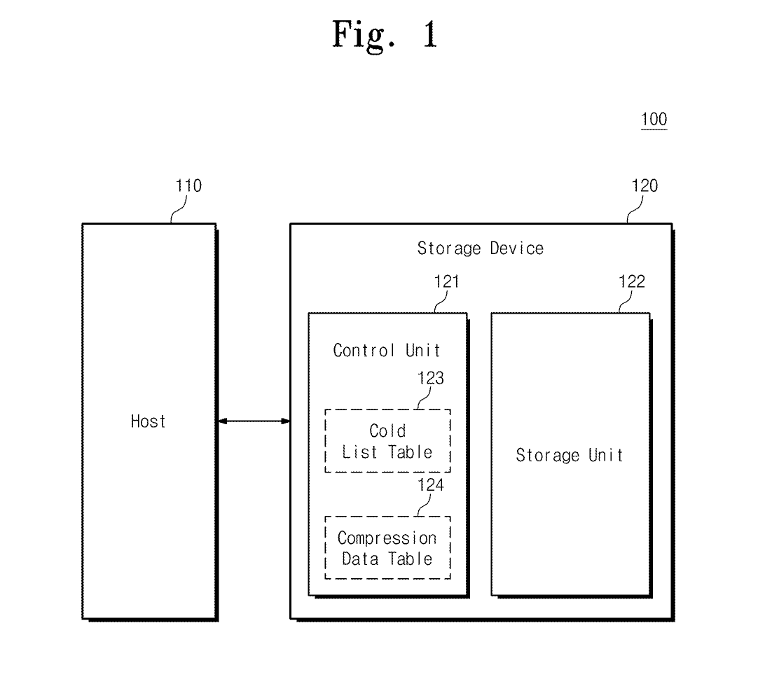

FIG. 1 is a block diagram schematically illustrating a memory system 100 capable of storing compressed cold data according to an embodiment of the inventive concept. Referring to FIG. 1, the memory system 100 generally comprises a host 110 and a storage device 120. The storage device 120 comprises a control unit 121 and a storage unit 122.

The storage device 120 retrieves stored data stored in the storage unit 122 in response to a read request or writes (or programs) data to the storage unit 122 in response to a write request. The “access frequency” by the host 110 for data (i.e., the frequency with which data is accessed—read or written—over a given period of time) stored in the storage device 122 is an important and differentiating data characteristic and may be used to identify the relative access importance of data. Hereinafter, data more frequently accessed on a relative basis will be referred to as “hot data”, and data less frequently accessed will be referred to as “cold data”. Those skilled in the art will recognize that various standards (or metrics) may be used to differentiate hot data from cold data.

The memory space of the storage unit 122 that may be allocated to store data is finite in nature. To utilize the storage space of the storage unit 122 effectively, the storage device 120 within certain embodiments of the inventive concept are configured to compress cold data before storing the compressed cold data in the storage unit 122. To support classification and compression of cold data, the storage device 120 may be configured to manage cold data using a cold list table 123 and a compression data table 124.

The cold list table 123 may be used to classify data stored in the storage unit 122 according to a “cold value”. Herein, a cold value ascribed to certain data is a measure of access frequency, and may in certain embodiments be expressed as access per given unit of time. Hence, data having a large cold value is data having a relatively low access frequency. In contrast, data having a small cold value is data having a relatively high access frequency.

In the event a cold value is greater than predetermined reference value, the control unit 121 may be used to compress the corresponding cold data with reference to the cold list table 123. The resulting “compressed cold data” may then be stored in the storage unit 122.

The compression data table 124 may manage information associated with the compressed cold data. For example, the compression data table 124 may manage information associated with a compression rate (or compression ratio) of the compressed cold data, the data size of the cold data, etc. When decompression of the compressed cold data is required, the control unit 121 may perform a decompression operation of the compressed cold data with reference to the compression data table 121. For example, when compressed cold data is read in response to a read request received from the host 110, the control unit 121 may be used to perform a decompression operation on the compressed cold data with reference to the compression data table 124. Following the decompression operation, the storage device 120 may provide the host 110 with information associated with the decompressed cold data.

As described above, the memory system 100 according to an embodiment of the inventive concept may be configured to compress cold data and store the resulting compressed cold data in the storage unit 122. Accordingly, the memory system 100 may make efficient use of available memory space provided by the storage unit 122. Further, it is possible to reduce the time required to compress/decompress cold data.

The memory system 100 according to an embodiment of the inventive concept may use various memory devices as the storage device 120. For example, the storage device 120 of the memory system 100 may be formed of a flash memory, DRAM, RRAM, FRAM, PRAM, MRAM, or the like.

As described above, the flash memory may be characterized in that an erase operation must be performed before data is written and an erase unit is less than a write unit. Due to the characteristics, the flash memory may be managed by a Flash Translation Layer (FTL), and there may be generated a garbage block storing invalid data. The garbage block will typically be generated during a garbage collection operation.

In the event that a flash memory is used as a storage medium of the storage device in FIG. 1, the memory system 100 according to an embodiment of the inventive concept may perform operations of compressing cold data and storing the compressed cold data in conjunction with a garbage collection operation. This may be referred to as a “compressed garbage collection operation”. Below, a flash memory system supporting the compressed garbage collection operation will be more fully described.

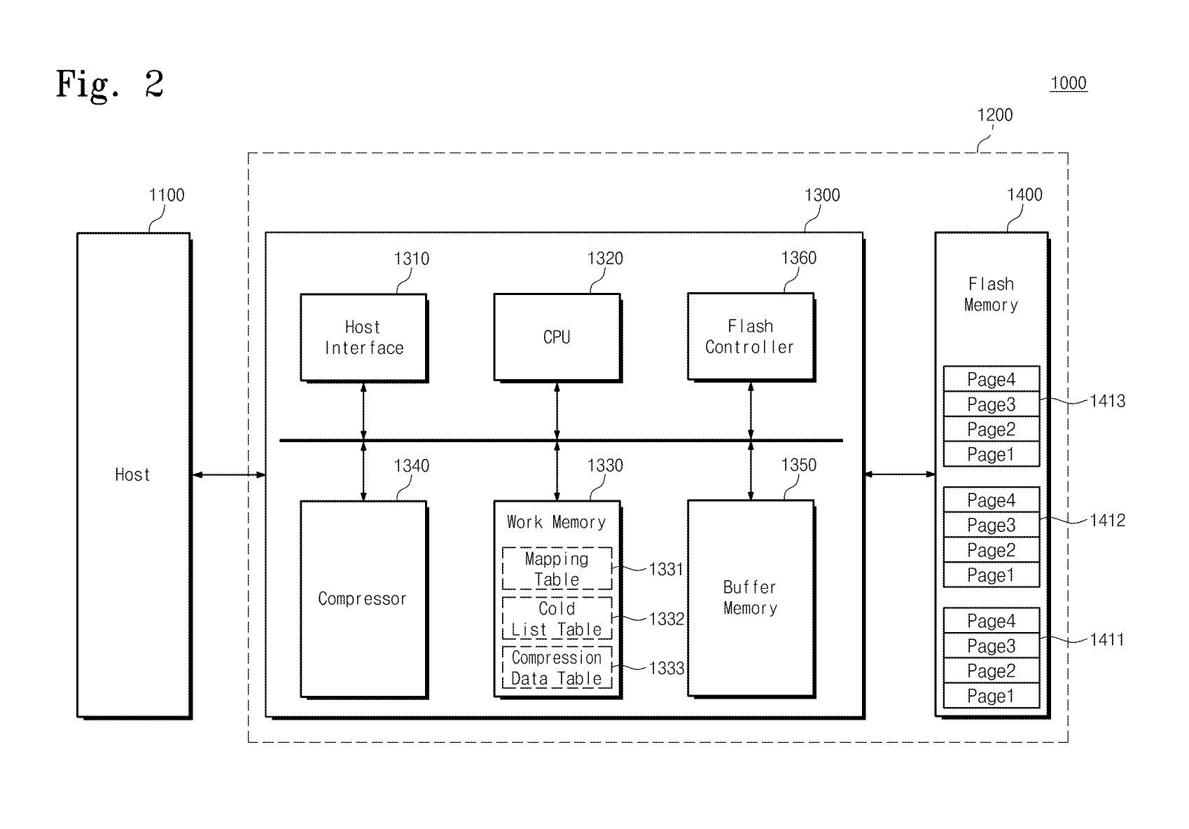

FIG. 2 is a block diagram schematically illustrating a flash memory system 1000 that supports a compressed garbage collection operation according to an embodiment of the inventive concept. Referring to FIG. 2, the flash memory system 1000 generally comprises a host 1100 and a flash storage device 1200. The flash storage device 1200 comprises a control unit 1300 and a flash memory 1400.

Upon an access request of the host 1100 on the flash memory 1400, the control unit 1300 may control the flash memory 1400. For example, the control unit 1300 may control a read operation, a write operation, or an erase operation of the flash memory 1400.

The control unit 1300 may manage mapping information of the flash memory 1400 such that the host 1100 recognizes the flash memory 1400 as a hard disk. The control unit 1300 may include a host interface 1310, a Central Processing Unit (CPU) 1320, a work memory 1330, a compressor 1340, a buffer memory 1350, and a flash controller 1360.

The host interface 1310 may provide an interface between the flash storage device 1200 and the host 1100. The CPU 1320 may control an overall operation of the flash storage device 1200.

The work memory 1330 may be used to store software necessary to implement an FTL function. The work memory 1330 may be used to store mapping information of the flash memory 1400. A mapping table 1331 including the mapping information may be stored in the work memory 1330.

The mapping table 1331 may be used to manage mapping information between logical addresses of the host 1100 and physical addresses of the flash memory 1400. Mapping information of the mapping table 1331 may be managed according to one of a block mapping technique, a page mapping technique, and a hybrid mapping technique.

Further, the mapping table 1331 may be used to manage information associated with whether data requested from the host 1100 is compressed cold data. For example, upon a read request of the host 1100, the control unit 1300 may judge whether data of a physical address PA corresponding to a logical address LA is compressed cold data, based on the mapping table 1331.

The work memory 1330 may be used to manage information associated with data compressing and decompressing operations. The work memory 1330 may include a cold list table 1332 and a compression data table 1333 to manage information associated with data compressing and decompressing operations.

The cold list table 1332 may be used to manage information associated with a cold value of each block or page of the flash memory 1400 in which data is stored. For example, if data stored in the flash memory 1400 is managed by the block, the cold list table 1332 may be used to manage information associated with a cold value corresponding to each block. In this case, the cold value may be determined on the basis of an access frequency, an access time, a generation time, etc. associated with each block.

In a case where a compressed garbage collection operation is executed, the control unit 1300 may collect a block (or, page), in which cold data is stored, from among blocks (or, pages) of the flash memory 1400, based on the cold list table 1332. A cold value of each block (or, page) managed by the cold list table 1332 may be updated whenever the host 1100 requests an access to each block (or, page).

The compression data table 1333 may be used to manage compression information of compressed cold data. For example, at the compressed garbage collection operation, the compression data table 1333 may be used to manage information such as a compression rate, a compression size, etc. associated with compressed cold data. If the host 1100 requests an access to compressed cold data, the control logic 1300 may perform a decompression operation on the compressed cold data, based on the compression data table 1333.

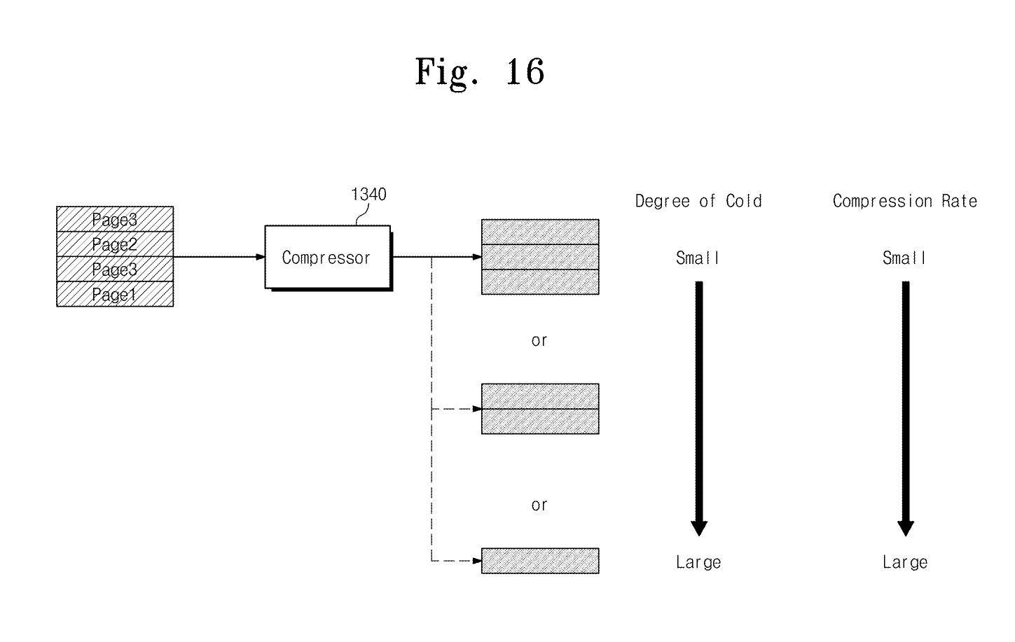

The compressor 1340 may compress cold data collected during the compressed garbage collection operation. Cold data compressed by the compressor 1340 may be stored in the flash memory 1400 via the buffer memory 1350. Below, a block of the flash memory 1400 in which the compressed cold data is stored may be referred to as a “compressed block” (CB). The compressor 1340 may be implemented to have different compression rates according to the cold value associated with corresponding cold data. This will be more fully described with reference to FIGS. 16 through 19.

The buffer memory 1350 may be used to buffer data when data is stored in the flash memory or when data is read out from the flash memory 1400. The buffer memory 1350 may have a storage capacity corresponding to a page size of the flash memory 1400. The buffer memory 1350 and the work memory 1330 may be implemented by a volatile memory such as SRAM, DRAM, and the like, respectively. Alternatively, the buffer memory 1350 and the work memory 1330 may be implemented by one volatile memory such as SRAM, DRAM, and the like.

The flash controller 1350 may be configured to control access operations (e.g., read, write, and erase operations) of the flash memory 1400 under the control of the CPU1320.

The flash memory 1400 may include a memory cell array formed of a plurality of memory blocks, each of which is formed of a plurality of pages. In FIG. 2, three memory blocks 1411, 1412, and 1413 each having four pages are exemplarily illustrated. Each memory cell of the flash memory 1400 may store one or more bits of data.

Memory blocks of the flash memory 1400 may be divided into a data region, a log region, and a meta region. However, the inventive concept is not limited thereto. Memory blocks of the flash memory 1400 may be divided variously according to a mapping technique of a flash translation layer FTL. Information of the mapping table 1331, the cold list table 1332, and the compression data table 1333 may be stored in the meta region of the flash memory 1400 at an idle time or every specific time, for example. Information of the mapping table 1331, the cold list table 1332, and the compression data table 1333 stored in the meta region may be loaded onto the work memory 1330 at power-up.

The flash memory system 1000 of FIG. 2 is said to “support” the compressed garbage collection operation. That is, the flash memory system 1000 may be configured to generate a garbage block by invalidating a page (or block) storing cold data, to compress cold data collected at the same time, and to store it in the flash memory 1400.

In the event that the compressed garbage collection operation is executed, the flash memory system 1000 may generate a garbage block by collecting a cold data set from cold data stored in the flash memory 1400. The cold data set may be “collected” (e.g., copied according to a defined arrangement) in a (e.g., high-access-speed DRAM and SRAM) volatile memory, such as the work memory 1330 or buffer memory 1350, by referencing the cold list table 1332, and thereafter invalidating a page (or block) previously storing the cold data making up the collected cold data set. Further, the flash memory system 1000 may compress the collected cold data set using the compressor 1340 to generate a compressed cold data set and then store the compressed cold data set in a specific region (e.g., a compressed region CB) of the flash memory 1400.

As the flash memory system 1000 supports the compressed garbage collection operation, it is possible to reduce or minimize the time required to compress cold data and access the memory space of the flash memory 1400 effectively.

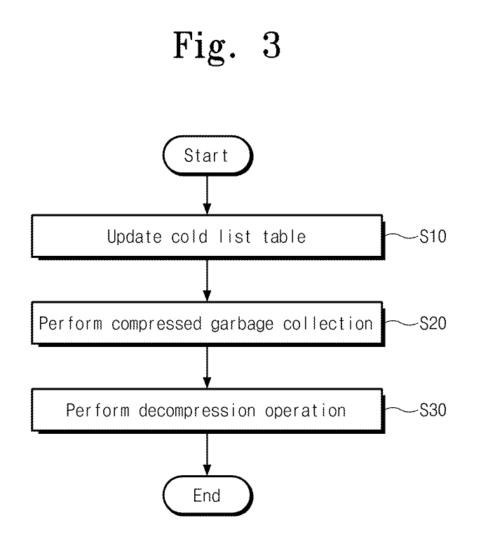

FIG. 3 is a flowchart summarizing a data management method that may be executed by the flash memory system 1000 of FIG. 2 supporting a compressed garbage collection operation. The method of managing data stored in the flash memory 1400 of the flash memory system 1000 comprises updating a cold list table 1332 (S10); performing a compressed garbage collection operation with reference to the cold list table 1332 (S20); and performing a decompression operation with reference to the mapping table 1331 and compression data table 1333 (S30). Hereafter, these exemplary methods steps S10, S20 and S30 will be described in some additional detail.

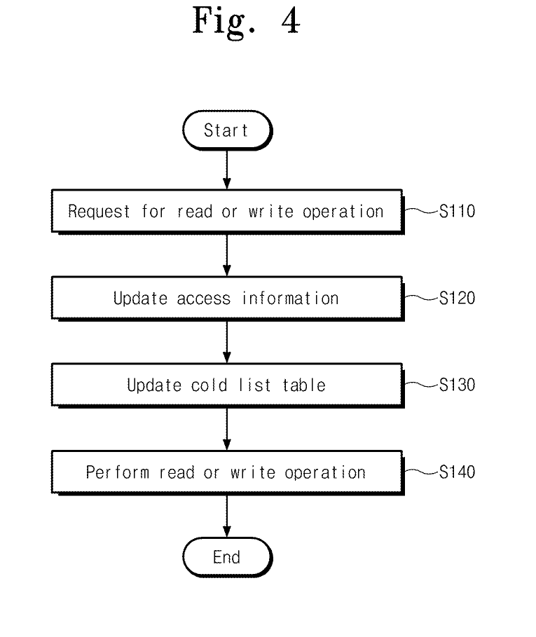

FIGS. 4 through 7 are diagrams further describing the step of updating the cold list table 1332 (S10) within the flash memory system 1000 of FIG. 2. As described in relation to FIG. 2, the cold list table 1332 may be updated whenever an access to a flash memory 1400 is requested. For ease of description, it is assumed that a flash translation layer FTL manages data using a conventionally understood page mapping technique.

Referring to the flowchart of FIG. 4, an access request related to a read or write operation to the flash memory 1400 is made (S110). For example, the host 1100 may request a read operation on data stored in the flash memory 1400, a write operation on new data, or an update operation on previously stored data.

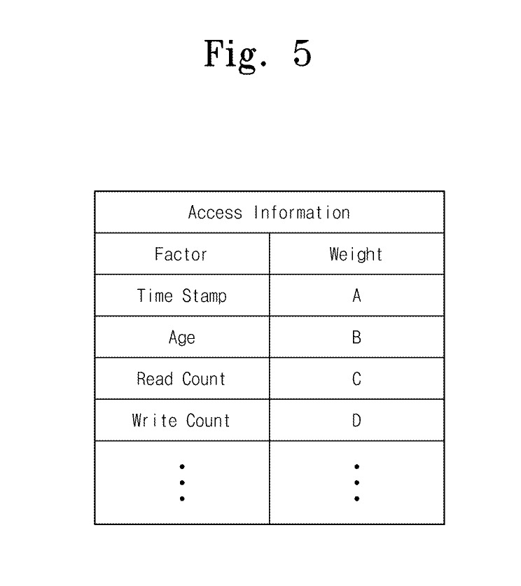

In response to the request, access information for the corresponding page is updated (S120). For example, as illustrated in FIG. 5, certain “access information” may include factors such as a time stamp of a corresponding page, an age of the corresponding page, a read count of data stored in the corresponding page, a write count of data stored in the corresponding page, and the like. These factors may have corresponding weights assigned. Each factor and weight of the access information may be defined variously according to a designer, and may be used to decide a cold value.

The access information may be stored in a meta region of the flash memory 1400, and may be loaded onto a work memory 1330 during a power-up operation. In a case where an access to the flash memory 1400 is requested, a control unit 1300 may update a value of each factor of access information associated with an access requested page. The updated access information may be stored in the work memory 1330.

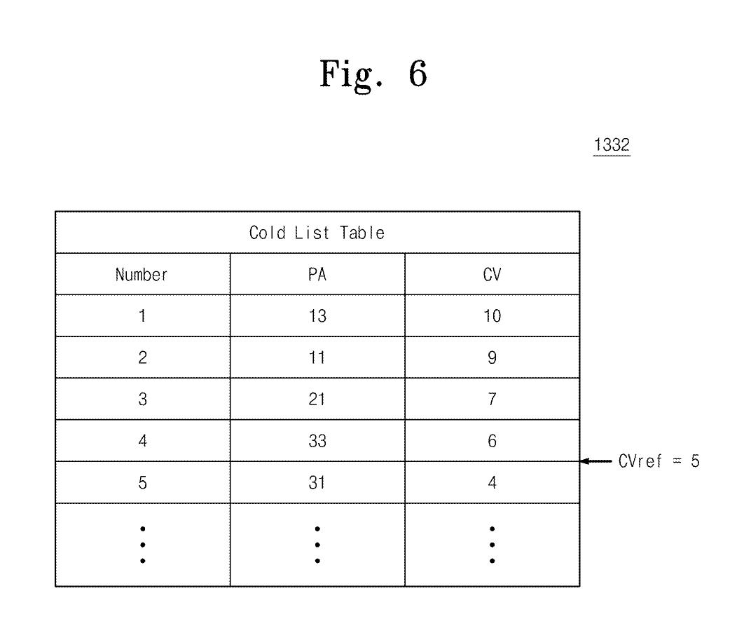

Returning to FIG. 4, the cold list table 1332 is updated (S130) before the read or write operation is performed (S140). For example, as illustrated in FIG. 6, the cold list table 1332 may include a physical address PA and a cold value CV of an access requested page. The cold value CV may be decided according to each factor and weight of access information of FIG. 5, and an equation of deciding the cold value CV may be defined variously according to a designer. In FIG. 6, a page having a relatively large cold value may indicate that the frequency of access of the page is low, and a page having a relatively small cold value may indicate that the frequency of access of the page is high.

The control unit 1300 may again calculate a cold value of a page based on the updated access information, and may sort pages sequentially according to cold values. In this case, pages having a cold value greater than a reference cold value CVref may be cold data, which becomes a target of a compressed garbage collection operation.

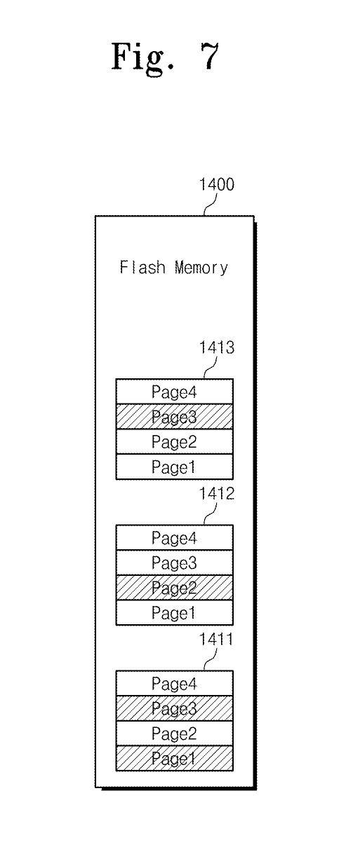

For example, as illustrated in FIGS. 6 and 7, in a case where the reference cold value CVref is set to 5, pages (e.g., first and third pages of a first block 1411, a second page of a second block 1412, and a third page of a third block 1413 in FIG. 7) having a cold value greater than 5 (i.e., the reference cold value CVref) may be cold data, which becomes a target of a compressed garbage collection operation.

As described above, the cold list table 1332 may be updated whenever an access to the flash memory 1400 is requested. Accordingly, if a compressed garbage collection operation is executed later, the control unit 1300 may determine cold data based on the cold list table 1332.

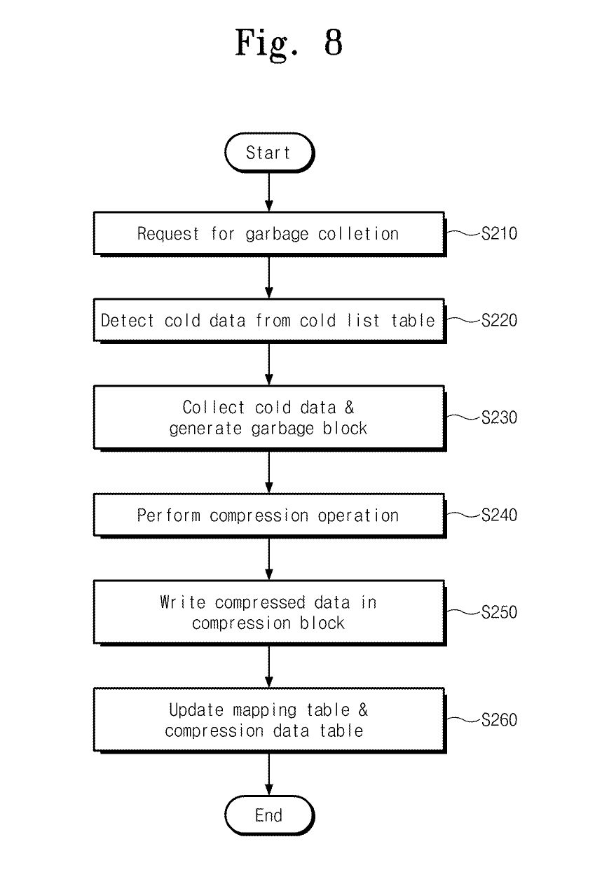

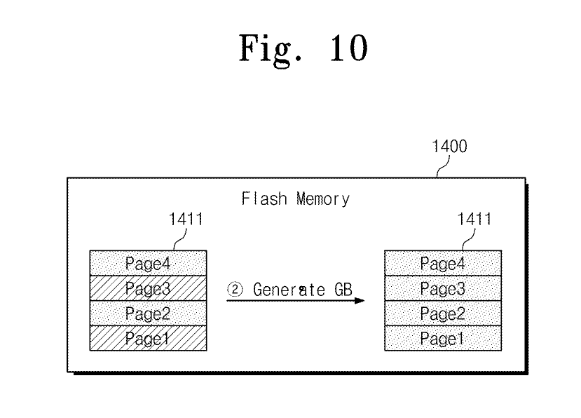

FIGS. 8 through 13 are diagrams describing a compressed garbage collection operation that may be performed by the flash memory system 1000 of FIG. 2. As described in relation to FIG. 2, at a compressed garbage collection operation, a flash memory system 1000 may be configured to generate a garbage block by invalidating cold data, to compress cold data, and to store it in a flash memory 1400. Accordingly, it is possible to reduce or minimize the time taken to compress cold data and to use a storage space of the flash memory 1400 effectively.

For ease of description, it will again be assumed that a flash translation layer FTL manages data according to a page mapping technique. Further, as described in relation to FIGS. 6 and 7, it is assumed that a reference cold value is 5 and cold pages are first and third pages of a first block 1411, a second page of a second block 1412, and a third page of a third block 1413. Further, it is assumed that data of second and third pages of the first block 1411 is invalid data.

Referring to FIG. 8, a garbage collection operation may be requested (S210). That is, if empty blocks of the flash memory 1400 are insufficient, the flash storage device 1200 may perform the garbage collection operation for generating empty blocks. Herein, an empty block may be a block in which no data is written.

In an embodiment, an operation of making a garbage block and an operation of compressing cold data may be executed at the same time. Accordingly, a garbage collection operation of the inventive concept may be named a compressed garbage collection operation. The garbage collection operation may be executed at an idle time of the flash storage device 1200.

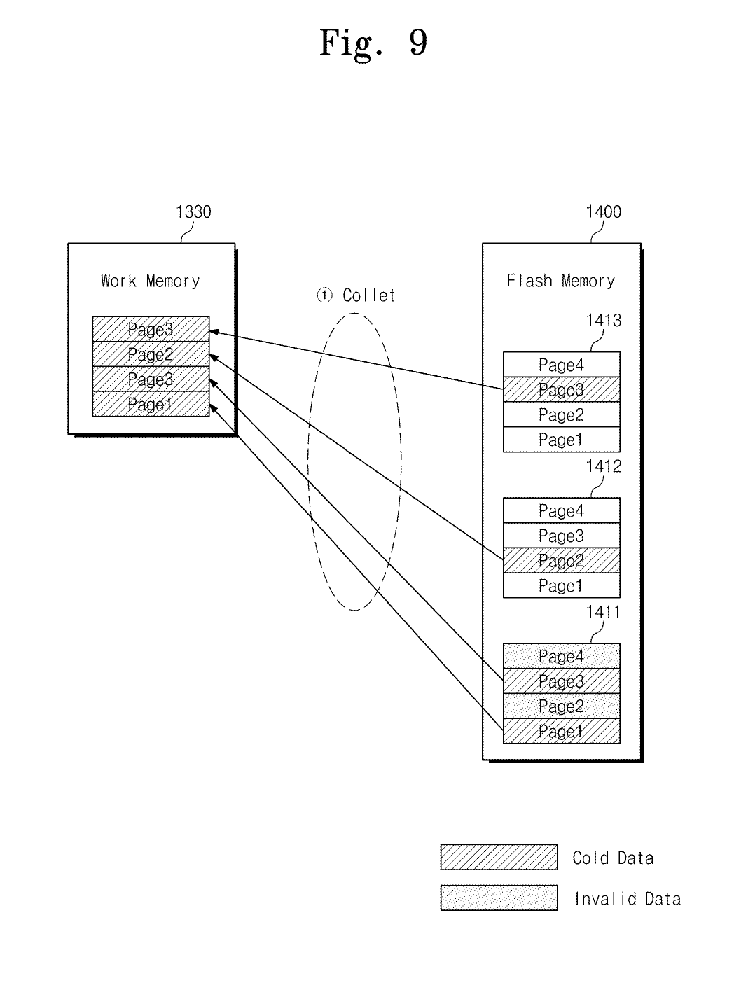

The, a control unit 1300 may be used to detect cold data with reference to the cold list table 1332 (S220). For example, as illustrated in FIG. 9, the control unit 1300 may determine pages (first and third pages of a first block 1411, a second page of a second block 1412, and a third page of a third block 1413) having a cold value greater than 5 to be cold pages with reference to the cold list table 1332.

Next, cold data may be collected using the work memory 1330 (S230). Further, a garbage block may be prepared by invalidating source pages in which cold data was stored. For example, as illustrated in FIG. 9, the control unit 1300 may collect cold data (i.e., first and third pages of a first block 1411, a second page of a second block 1412, and a third page of a third block 1413) in the work memory 1330.

Once cold data is collected at the work memory 1330, source pages in which cold data was stored may be invalidated. Accordingly, the control unit 1300 may create an empty block (i.e., a block capable of storing newly received data) by erasing the first block 1411 determined to be a garbage block.

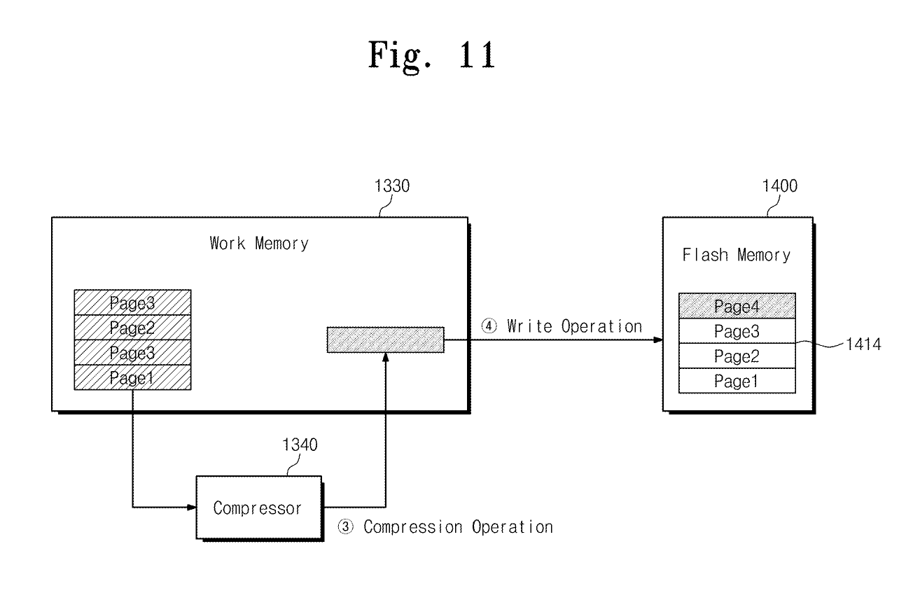

Cold data collected at the work memory 1330 may now be compressed (S240). For example, as illustrated in FIG. 11, the compressor 1340 may compress cold data collected at the work memory 1330. In an embodiment, the compressor 1340 may be implemented to have various compression rates (or ratios) according the level of a reference cold value. As the reference cold value increases, the compressor 1340 may operate according to a higher compression rate.

The cold data compressed by the compressor 1340 is then stored in a defined region of the flash memory 1400 (S250). Herein, a memory block in which compressed cold data is stored will be referred to as a “compressed block” or CB. For example, as illustrated in FIG. 11, cold data compressed by the compressor 1340 is stored in a fourth page of a fourth block 1414 of the flash memory 1400, and the fourth block 1414 may be referred to as a compressed block CB.

The mapping table 1331 and compression data table 1333 may now be updated (S260). For example, as illustrated in FIG. 11, the compressed cold data is stored at the fourth page of the fourth block 1414. Thus, the control unit 1300 may update the mapping table 1331 such that logical addresses 1 through 4 corresponding to cold data are mapped onto a physical address 44. Further, the control unit 1300 may update compressed state information CSI such that data stored at the physical address 44 indicates compressed data.

Further, as illustrated in FIG. 13, the control unit 1300 may update the compression data table 1333 such that compression information of the compressed cold data is stored. For example, the compression data table 1333 may be used to manage information such as a physical address of a page, in which compressed cold data is stored, a compression rate, a compression size, and the like. Compression information managed using the compression data table 1333 may be defined variously according to a method implemented by the compressor 1340.

Information managed using the tables 1331 and 1333 may be used to perform a decompression operation when an access to the compressed cold data is requested later.

As described above, when an empty block is needed, the flash storage device 1200 may prepare a garbage block by performing the compressed garbage collection operation. As the flash memory system 1000 supports the compressed garbage collection operation, it is possible to minimize a time taken to compress cold data and to use a storage space of the flash memory 1400 effectively.

The above description may be interpreted to be exemplary, and the inventive concept is not limited thereto. For example, collection and compression can be made using a buffer memory 1350, not a work memory 1330. Below, a compressed garbage collection operation according to another embodiment of the inventive concept will be described.

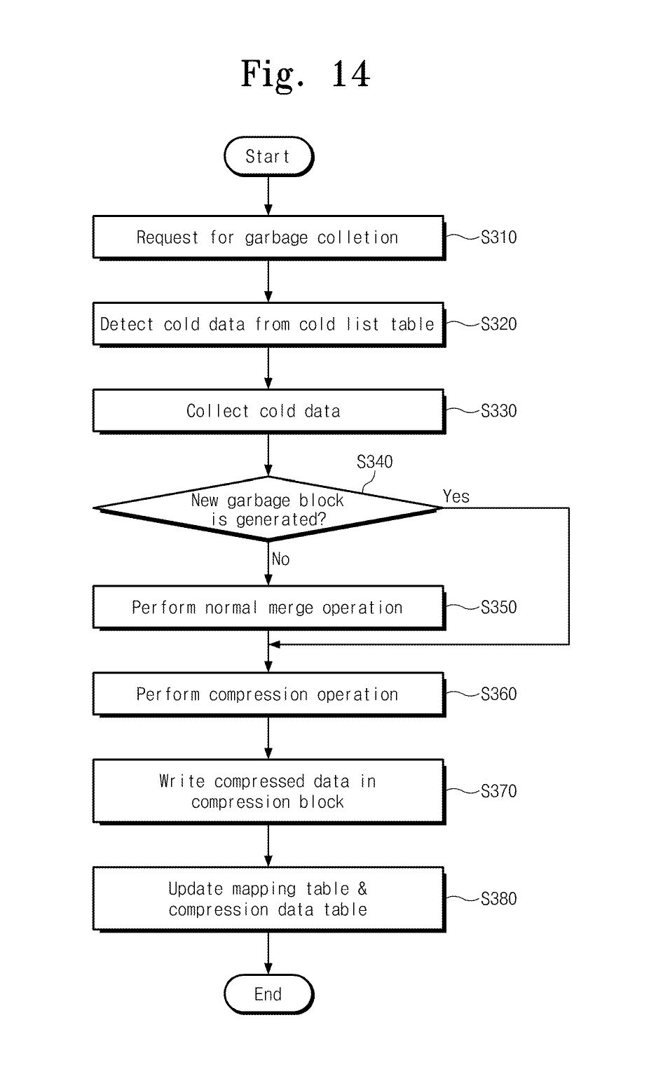

FIG. 14 is a diagram illustrating in one embodiment a compressed garbage collection operation that may be performed by the flash memory system of FIG. 2. The compressed garbage collection operation of FIG. 14 may be similar to that of FIG. 8. Below, only aspects distinguished from the compressed garbage collection operation of FIG. 8 will be described in detail.

Referring to FIG. 14, upon requesting of a garbage collection operation (S310), a control unit 1300 may detect cold data based on a cold list table 1332 (S320), and may collect the cold data at a work memory 1330 (S330). In this case, source pages, in which cold data is stored, may be invalidated.

Afterward, a determination is made as to whether a new garbage block is generated (S340).

In the event that a new garbage block is generated, the control unit 1300 may compress cold data (S360), store the compressed data in a compressed block (S370), and update a mapping table 1331 and a compression data table 1333. An operation of generating a new garbage block may be similar to that described in relation to FIG. 8, and description thereof is thus omitted.

If a new garbage block is not generated, the control unit 1300 may perform a normal merge operation. That is, unlike FIG. 8, in the even that a garbage block is not generated although pages in which cold data is stored are invalidated, the control unit 1300 may perform a normal merge operation to generate a garbage block. The merge operation may be iteratively executed until a new garbage block is generated. If a new garbage block is generated, it may be erased. Cold data collected at the work memory 1330 may be compressed (S360), the compressed cold data may be stored in a compressed block (S370), and the mapping table 1331 and the compression data table 1333 may be updated (S380).

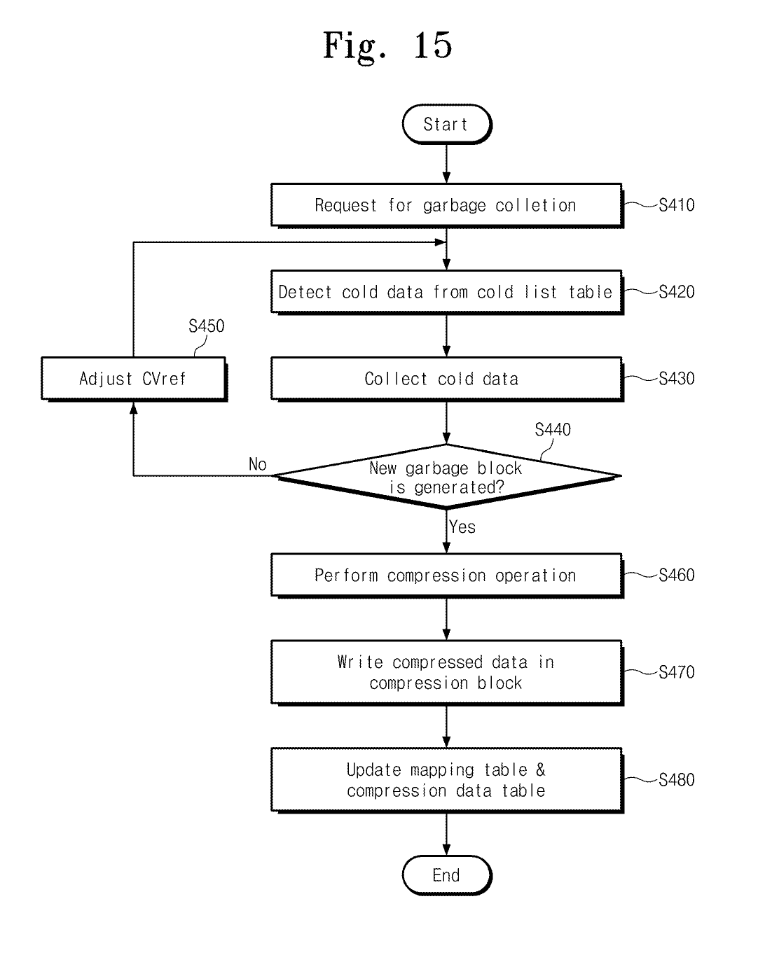

FIG. 15 is a diagram illustrating in another embodiment a compressed garbage collection operation that may be performed by the flash memory system of FIG. 2. The compressed garbage collection operation of FIG. 15 is similar to that of FIG. 14, except however, that a reference cold value CVref is adjusted when a new garbage block is not generated (S440=NO). Below, this distinguishing aspect relative to the compressed garbage collection operation of FIG. 14 will be described in some additional detail.

Referring to FIG. 15, a control unit 1300 may be used to determine whether a new garbage block is generated after pages storing cold data are invalidated (S440).

In a case where a new garbage block is not generated, the control unit 1300 may be used to adjust a reference cold value CVref to generate a garbage block (S450). This may be because the amount of cold data increases when the reference cold value CVref is lowered.

The number of pages determined to be cold data may increase by setting the reference cold value CVref to a lower value. For example, referring to FIG. 6, if the reference cold value CVref is adjusted from 5 to 4, the number of pages determined to be cold data increases by 1.

Thus, the control unit 1300 may reset the reference cold value CVref to a lower value as compared with a previous value (S450), detect cold data from a cold list table 1332 (S420), and judge whether a new garbage block is generated (S430). In the illustrated embodiment, the adjustment of the reference cold value CVref may be executed in response to the non-generation of a new garbage block.

As described in relation to FIGS. 14 and 15, a compressed garbage collection operation according to embodiments of the inventive concept may be applied variously.

Returning to FIG. 2, the compressor 1340 may be implemented using various approaches. For example, the compressor 1340 may be implemented with a constant compression rate. Alternatively, the compressor 1340 may be implemented with a variable compression rate. This will be more fully described below.

FIG. 16 is a conceptual diagram describing operation of one possible compressor for the memory system of FIG. 2. In FIG. 16, the operation of the compressor with variable compression rates may be controlled in accordance with a “degree of cold” (e.g., with reference to cold values for stored data). For ease of description, it is assumed that the compressor 1340 is capable of operating with one of three compression rates.

Referring to FIG. 16, the compressor 1340 may operate with a low compression rate when the degree of cold is relatively low, or with a higher compression rate when the degree of cold is relatively high. Herein, the term “degree of cold” denotes the of an average cold value for the cold data collected in the a work memory 1330. For example, if a reference cold value CVref is high, cold data will have a high cold level. If the reference cold value CVref is low, cold data will have a low cold level.

The probability of an access request directed to cold data having a high cold level is relatively low as compared with cold data having a low cold level. Further, if the compression rate is high, a long time may be required to decompress the compressed data, whereas if a compression rate is low, a shorter time will be required.

The use of a storage space of a flash memory 1400 may be maximized by compressing cold data of which the probability of an access request is low, using a relatively large compression rate. On the other hand, a time taken for decompression may be minimized by compressing cold data of which the probability of an access request is high, using a relatively small compression rate.

That is, the time taken for decompression and the use of a storage space of a flash memory 1400 may be simultaneously considered by selecting one of different compression rates of the compressor 1340 according to the degree of cold or a reference cold value CVref.

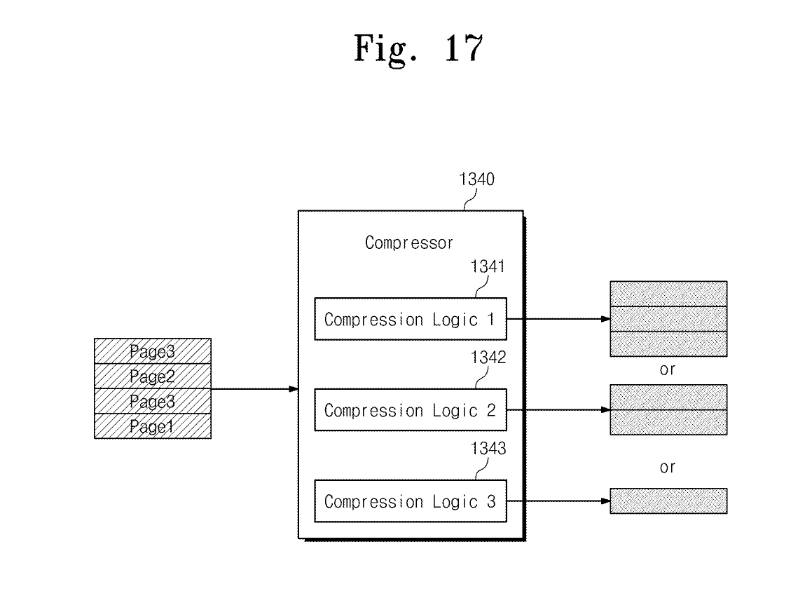

FIG. 17 is another conceptual diagram illustrating operation of a compressor according to an embodiment of the inventive concept. For ease of description, it is assumed that a compressor 1340 has three different compression rates.

Referring to FIG. 17, the compressor 1330 may include first through third compression logics 1341 through 1343. The first through third compression logics 1341 through 1343 may have different compression rates from one another.

For example, the first compression logic 1341 may have the lowest compression rate. Accordingly, in the even that cold data collected at a work memory 1330 has a relatively high cold level (or, a high reference cold value), the compressor 1340 may compress cold data using the first compression logic 1341. The third compression logic 1343 may have the highest compression rate. Accordingly, in the event that cold data collected at a work memory 1330 has a relatively low cold level (or, a low reference cold value), the compressor 1340 may compress cold data using the third compression logic 1343.

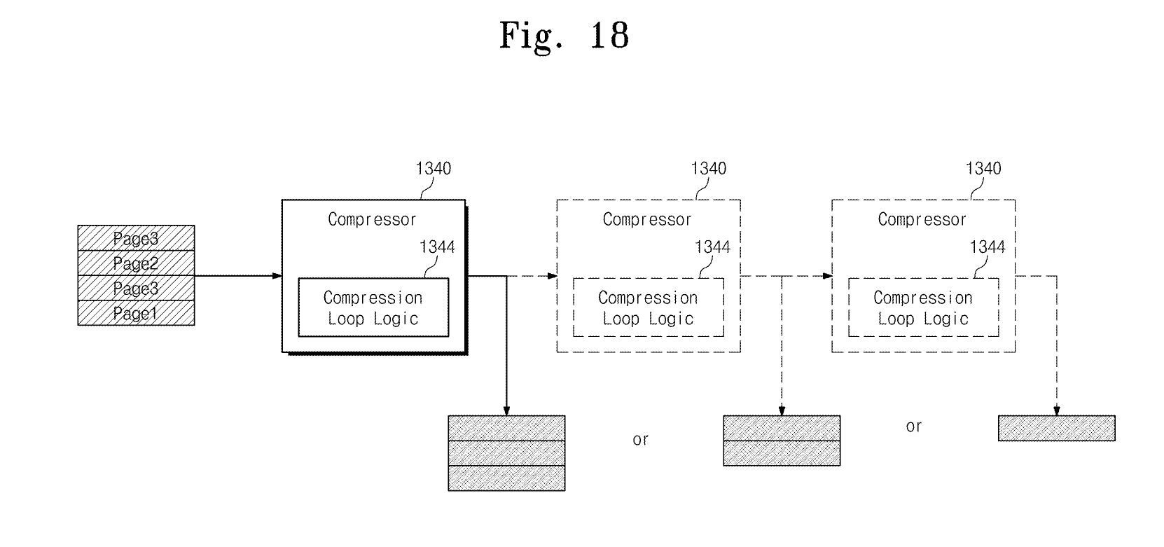

FIG. 18 is yet another conceptual diagram illustrating a compressor according to another embodiment of the inventive concept. For ease of description, it is assumed that three different compression rates are provided using a compressor 1340.

Referring to FIG. 18, the compressor 1340 may include one compression logic 1344, and may provide three different compression rates by adjusting an iterative number of compression operation(s). For example, in the event that cold data collected at a work memory 1330 has a relatively high cold level (or, a high reference cold value), the compressor 1340 may perform a compression operation three times in order to compress the implicated cold data. On the other hand, in the event that cold data collected at a work memory 1330 has a relatively low cold level (or, a low reference cold value), the compressor 1340 may perform a compression operation only once in order to compress the cold data. Accordingly, the compressor 1340 in FIG. 18 may compress cold data with different compression rates according to the degree of cold (or a reference cold value), by adjusting the number of applied compression operations.

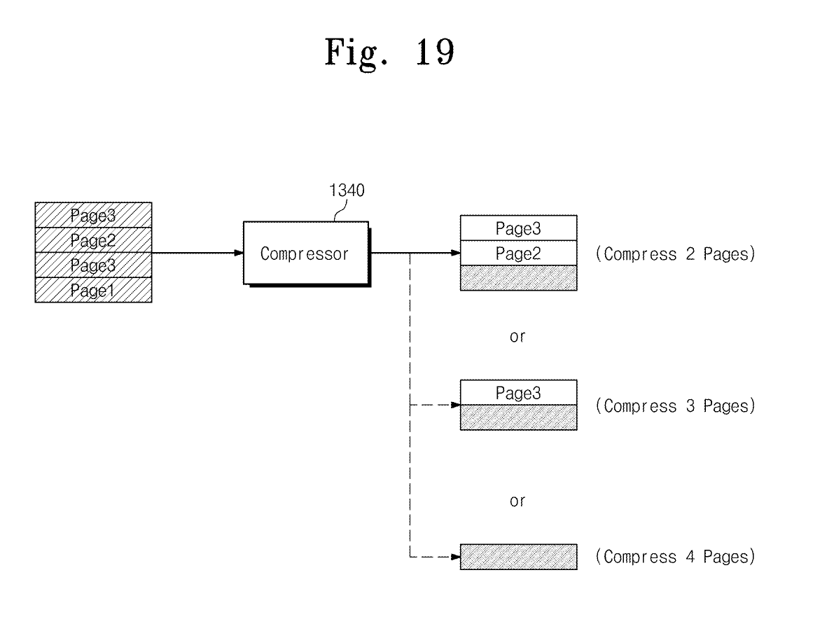

FIG. 19 is still another conceptual diagram illustrating operation of a compressor according to still another embodiment of the inventive concept. For ease of description, it is assumed that three different compression rates are provided using a compressor 1340.

Referring to FIG. 19, the compressor 1340 may provide three different compression rates by compressing a part of cold data. For example, as illustrated in FIG. 19, it is assumed that cold data stored at four pages are collected at a work memory 1330.

In this case, if cold data collected at a work memory 1330 has a relatively high cold level (or, a high reference cold value), the compressor 1340 may compress all cold data corresponding to four pages. Alternatively, in the event that cold data collected at a work memory 1330 has a relatively low cold level (or, a low reference cold value), the compressor 1340 may compress cold data, corresponding to two pages, from among collected data. In this case, a “grouping” of cold data being partially compressed by the compressor 1340 may have a compression rate which is determined differently according to the degree of cold (or, a reference cold value).

As described above, the compressor 1340 according to certain embodiments of the inventive concept may be implemented by various methods. Further, compression information of a compression data table 1333 may be set variously according to an implemented method of the compressor 1340.

Hereafter, a data management method for the flash memory device 1000 of FIG. 2 will be described under an assumption that an access request is directed to compressed cold data.

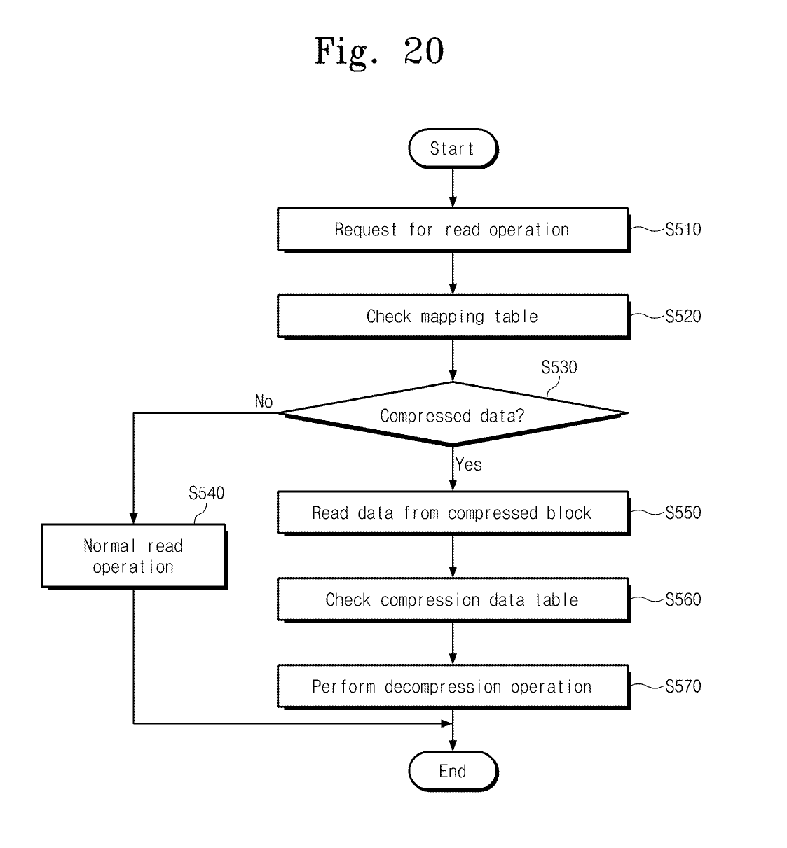

FIG. 20 is a flowchart summarizing an access operation of a flash memory device according to an embodiment of the inventive concept. For ease of description, it is assumed that a read operation directed to the flash memory device 1000 is requested from the host 1100.

A read operation is assumed to be requested from the host 1100 (S510).

Next, the control unit 1300 check the physical address PA corresponding to a read-requested logical address LA with reference to the mapping table 1331 (S520).

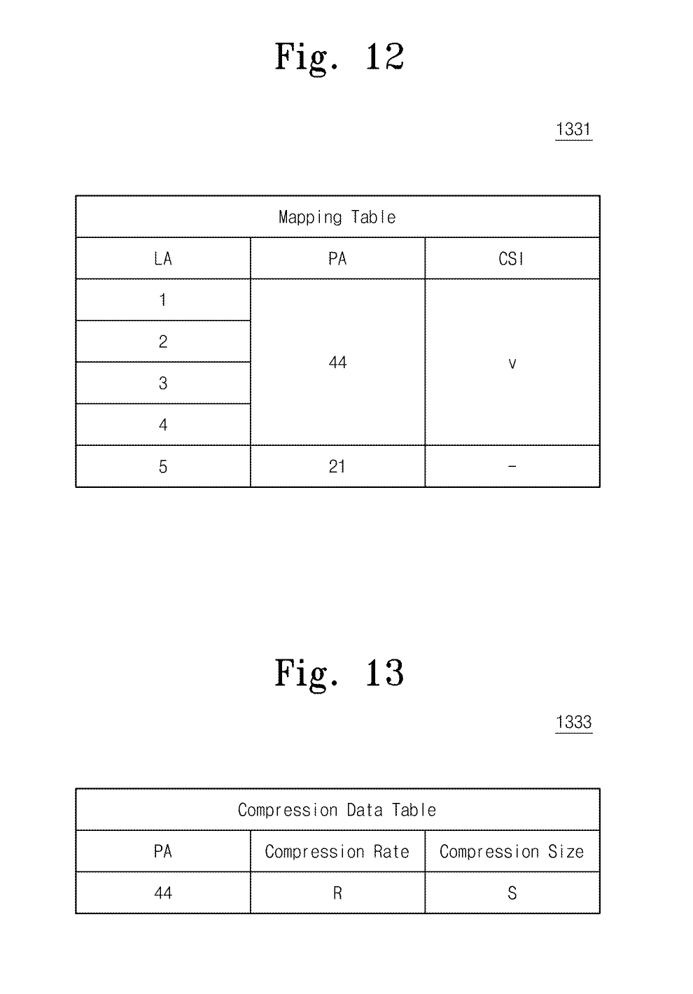

The control unit 1300 determines whether the read-requested data is compressed cold data (S530) based on compression state information CSI (refer to FIG. 12) stored in the mapping table 1331.

If the read-requested data is compressed cold data (S530=YES), the control unit 1300 may load data stored in a compressed block CB onto a work memory 1330 via a buffer memory 1350 (S550). Then, the control unit 1300 may check compression information associated with the compressed cold data, based on a compression data table 1333 (S560). Afterwards, the control unit 1300 may perform a decompression operation based on the compression information associated with the compressed cold data. The decompression operation may be executed by a reverse process of a compression operation described in relation to FIGS. 16 through 19 (S570) and a detailed description thereof is thus omitted.

However, if the read-requested data is not compressed cold data (S530=NO), a normal read operation may be executed (S540).

As described in relation to FIGS. 2 through 20, a memory system 10 in FIG. 1 may use a flash memory as a storage unit 122 (refer to FIG. 1), and a flash memory system 1000 in FIG. 2 may support a compressed garbage collection operation. Accordingly, it is possible to minimize a time taken to compress cold data and to use a storage space of a flash memory 1400 effectively.

The above description may be interpreted to be exemplary, and the inventive concept is not limited thereto. Below, applications of a memory system 10 in FIG. 1 or a flash memory system 1000 in FIG. 2 will be described.

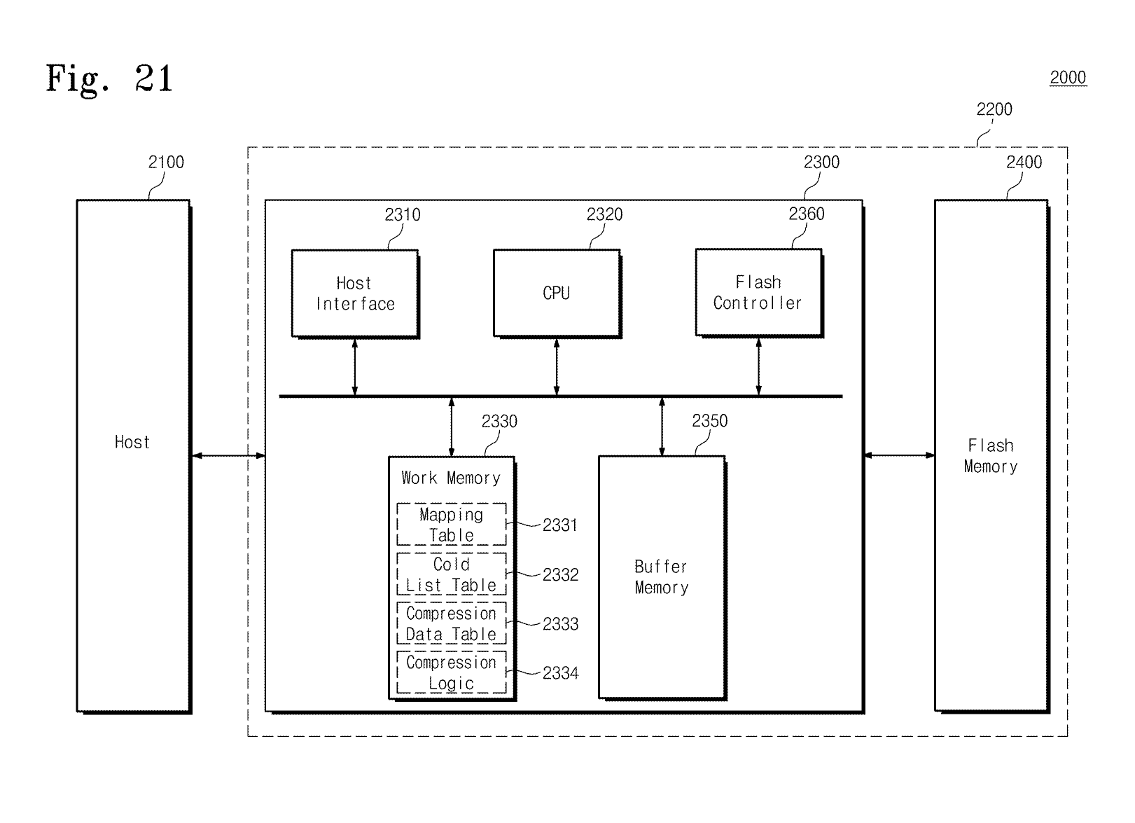

FIG. 21 is a block diagram schematically illustrating a flash memory system 2000 capable of performing data compression using stored compression software according to another embodiment of the inventive concept. The flash memory system 2000 may be similar to that of FIG. 2, and similar elements are labeled with similar reference numbers.

Referring to FIG. 21, the flash memory system 2000 generally comprises a host 2100 and a flash storage device 2200. The flash storage device 2200 comprises a control unit 2300 and a flash memory 2400.

Unlike a control unit 1300 in FIG. 2, the control unit 2300 in FIG. 21 may be configured such that compression logic 2334 is loaded on a work memory 2330. Herein, the compression logic 2334 may be software executing a compression operation of cold data upon a compressed garbage collection operation. The compression logic 2334 may be stored in a meta region of the flash memory 2400, and may be loaded onto the work memory 2330 at a power-up operation.

The compression logic 2334 may compress cold data with a constant compression rate. Alternatively, as described in relation to FIGS. 16 through 19, the compression logic 2334 may compress cold data with different compression rates according to the degree of cold (or, a reference cold value).

The flash memory system 1000 of FIG. 2 may be applied to various products. A host 1100 may be a computer, a digital camera, a cellular phone, an MP3 player, a PMP, a game machine, or the like. A flash storage device 1200 may be a flash memory-based SSD, a flash memory card, or a flash memory module. The host 1100 and the flash storage device 1200 may be interconnected via the standardized interface such as an ATA, SATA, PATA, USB, SCSI, ESDI, PCI express, or IDE interface.

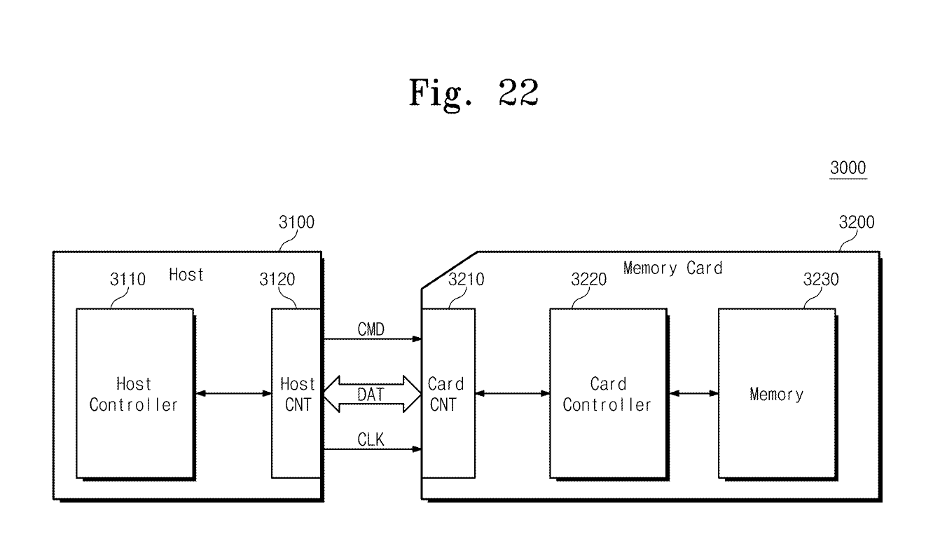

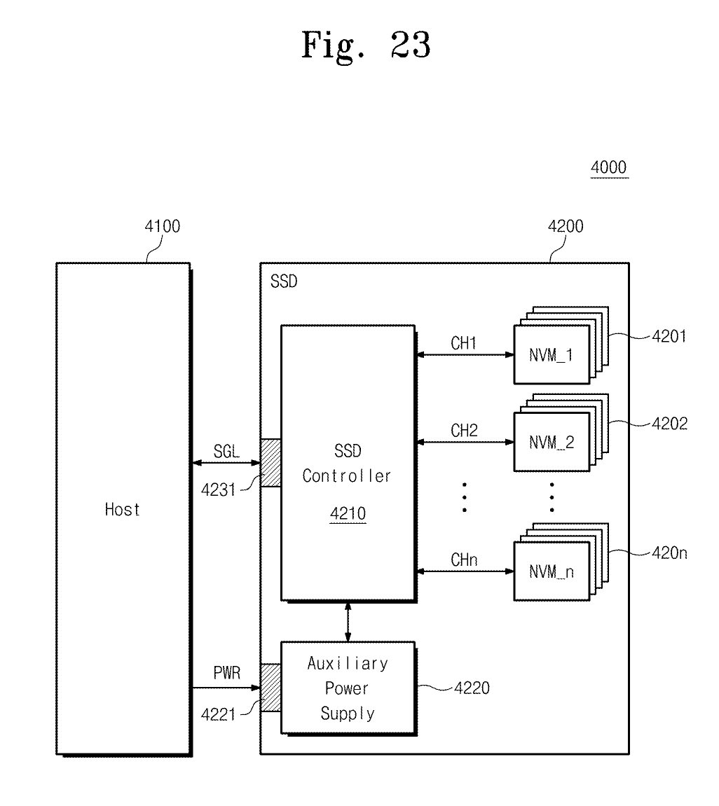

FIG. 22 is a block diagram illustrating a memory card system to which a flash memory system according to an embodiment of the inventive concept is applied. A memory card system 3000 may include a host 3100 and a memory card 3200. The host 3100 may include a host controller 3110 and a host connection unit 3120. The memory card 3200 may include a card connection unit 3210, a card controller 3220, and a flash memory 3230.

Each of the host connection unit 3120 and the card connection unit 3210 may be formed of a plurality of pins. The pins may include a command pin, a data pin, a clock pin, a power pin, and the like. The number of pins may differentiate according a type of the memory card 3200. For example, an SD card may have nine pins.

The host 3100 may write data in the memory card 3200 and read data from the memory card 3200. The host controller 3110 may send a command (e.g., a write command), a clock signal CLK generated from a clock generator (not shown) in the host 3100, and data to the memory card 3200 via the host connection unit 3120.

The card controller 3220 may store data in the flash memory 3230 in response to a command input via the card connection unit 3210. The data may be stored in synchronization with a clock signal generated from a clock generator (not shown) in the card controller 3220. The flash memory 3230 may store data transferred from the host 3100. For example, in a case where the host 3100 is a digital camera, the flash memory 3230 may store image data.

In FIG. 22, the card controller 3220 may generate a garbage block using a compressed garbage collection operation. That is, the memory card system in FIG. 22 may support the above-described compressed garbage collection operation.

FIG. 23 is a block diagram illustrating a solid state drive system including a storage system to which a compressed garbage collection technique according to an embodiment of the inventive concept is applied. Referring to FIG. 23, a solid state drive (SSD) system 4000 may include a host 4100 and an SSD 4200. The SSD 4200 may send and receive signals to and from the host 4100 via a signal connector 4231 and may be supplied with a power via a power connector 4221. The SSD 4200 may include a plurality of nonvolatile memory devices 4201 through 420n, an SSD controller 4210, and an auxiliary power supply 4220.

The plurality of nonvolatile memories 4201 to 420n may be used as a storage unit of the SSD 4200. The plurality of nonvolatile memories 4201 to 420n may be implemented by a mass-storage flash memory device. The SSD 4200 may be mainly formed of a flash memory.

The plurality of nonvolatile memories 4201 to 420n may be connected with the SSD controller 4210 via a plurality of channels CH1 to CHn. One channel may be connected with one or more nonvolatile memories. Nonvolatile memories connected with one channel may be connected with the same data bus. In this case, a flash defrag may be made on the basis of a super-block in which a plurality of memory blocks are interconnected to form one block, or on the basis of a super-page in which a plurality of pages are connected to form one page.

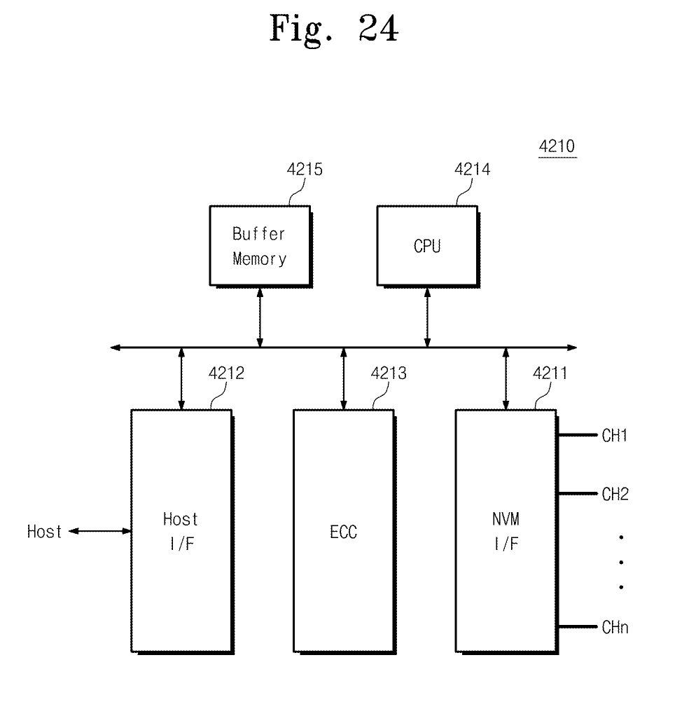

The SSD controller 4210 may exchange signals SGL with the host 4100 via the signal connector 4231. Herein, the signals SGL may include a command, an address, data, and the like. The SSD controller 4210 may be configured to write or read out data to or from a corresponding nonvolatile memory according to a command of the host 4100. The SSD controller 4210 will be more fully described with reference to FIG. 24.

The auxiliary power supply 4220 may be connected with the host 4100 via the power connector 4221. The auxiliary power supply 4220 may be charged by a power PWR from the host 4100. The auxiliary power supply 4220 may be placed within the SSD 4200 or outside the SSD 4200. For example, the auxiliary power supply 4220 may be put on a main board to supply an auxiliary power to the SSD 4200.

FIG. 24 is a block diagram schematically illustrating an SSD controller in FIG. 23. Referring to FIG. 24, an SSD controller 4210 may include an NVM interface 4211, a host interface 4212, an ECC block 4213, a CPU 4214, and a buffer memory 4215.

The NVM interface 4211 may scatter data transferred from the buffer memory 4215 to channels CH1 to CHn, respectively. The NVM interface 4211 may transfer data read from nonvolatile memories 4201 to 420n to the buffer memory 4215. Herein, the NVM interface 4211 may use a NAND flash interface manner. That is, the SSD controller 4210 may perform a program, read, or erase operation according to the NAND flash interface manner.

The host interface 4212 may provide an interface with an SSD 4200 according to the protocol of the host 4100. The host interface 4212 may communicate with the host 4100 using USB(Universal Serial Bus), SCSI(Small Computer System Interface), PCI express, ATA, PATA(Parallel ATA), SATA(Serial ATA), SAS(Serial Attached SCSI), etc. The host interface 4212 may perform a disk emulation function which enables the host 4100 to recognize the SSD 4200 as a hard disk drive (HDD).

The CPU 4214 may parse and process a signal SGL input from the host 4100 (refer to FIG. 23). The CPU 4214 may control the host 4100 or the nonvolatile memories 4201 through 420n via the host interface 4212 or the NVM interface 4211. The CPU 4214 may control the nonvolatile memories 4201 through 420n according to firmware for driving the SSD 4200.

The buffer memory 4215 may be used to temporarily store write data provided from the host 4100 or data read from a nonvolatile memory. The buffer memory 4215 may store metadata to be stored in the nonvolatile memories 4201 through 420n or cache data. At a sudden power-off operation, metadata or cache data stored in the buffer memory 4215 may be stored in the nonvolatile memories 4201 to 420n. The buffer memory 4215 may include DRAM, SRAM, and the like.

The SSD 400 illustrated in FIGS. 23 and 24 may support the above-described compressed garbage collection operation.

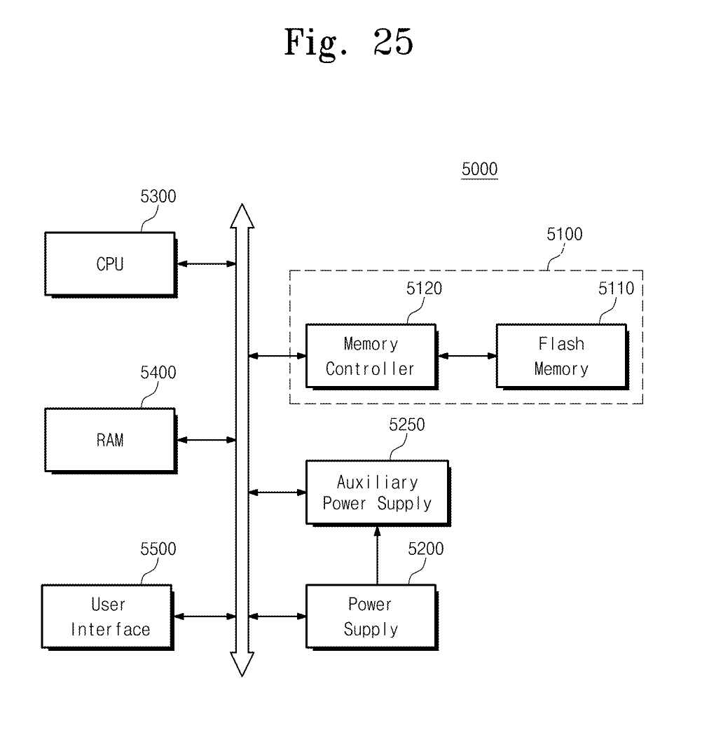

FIG. 25 is a block diagram illustrating a flash memory module to which acompressed garbage collection operation according to an embodiment of the inventive concept is applied. Herein, a flash memory module 5000 may be connected with a personal computer, a notebook, a cellar phone, a PDA, a camera, and the like.

Referring to FIG. 25, the flash memory module 5000 may include a memory system 5100, a power supply 5200, an auxiliary power supply 5250, a CPU 5300, a RAM 5400, and a user interface 5500. The flash memory module 5000 may support a compressed garbage collection operation as described above.

The above-disclosed subject matter is to be considered illustrative, and not restrictive, and the appended claims are intended to cover all such modifications, enhancements, and other embodiments, which fall within the scope of the inventive concept. Thus, to the maximum extent allowed by law, this scope will be determined by the broadest permissible interpretation of the following claims and their equivalents, and shall not be restricted or limited to only the foregoing detailed description.

What is claimed is:

1. A data management method for a flash storage device including flash memory, the method comprising:
creating a cold list table identifying cold data stored in the flash memory;
collecting a set of the cold data in a volatile memory by referencing the cold list table to generate a cold data set, and then compressing the cold data set to generate a compressed cold data set; and thereafter,
storing the compressed cold data set in the flash memory.

2. The method of claim 1, further comprising:
after generating the cold data set, invalidating a page in the flash memory used to store at least a portion of the cold data set.

3. The method of claim 2, further comprising:
determining whether all pages of a block including the invalidated page are invalidated; and
if all pages of a block including the invalidated page are invalidated, erasing the block.

4. The method of claim 3, further comprising:
if all pages of a block including the invalidated page are not invalidated, performing a merge operation to generate a garbage block.

5. The method of claim 1, further comprising:
storing the cold list table in a nonvolatile memory ; and
updating the cold list table in the nonvolatile memory upon receiving a read operation directed to data stored in the flash memory and a write operation writing data to the flash memory.

6. The method of claim 1, wherein the cold list table stores respective cold values associated with the cold data, the cold value being determined using at least one of time stamp information, age information, and read count information.

7. The method of claim 6, wherein a compression rate of the cold data set increases with an increase in a cold value associated with the cold data set.

8. The method of claim 3, further comprising:
creating a compression data table storing compression rate information for the cold data; and
after storing the compressed cold data set in the flash memory, updating compression information for the compressed cold data set in the compression data table.

9. The method of claim 8, wherein the compression rate information includes at least one of compression size information and compression logic information.

10. The method of claim 8, further comprising:
upon receiving a read requested directed to the compressed cold set, performing a decompression operation with reference to compression information stored in the compression data table.

11. The method of claim 8, wherein the cold list table and compression data table are created upon power-up of the flash storage device.

12. A data management method for a flash storage device including flash memory and a work memory, the method comprising:
upon power-up of the flash storage device, creating a cold list table storing a cold value for a data page stored in the flash memory, creating a compression data table storing compression rate information for the data page, and storing access information for the data page;
in response to a received read request directed to the data page, updating the access information for the data page, updating the cold value for the data page in the cold list table, and performing the read operation,
wherein the data page is compressed cold data previously stored in the flash memory after being collected in the work memory and compressed according to compression rate information, and performing the read operation comprises decompressing the page data in accordance with the compression rate information.

13. The method of claim 12, wherein the access information includes at least one of a time stamp for the data page, an age indication for the data page, a read count indication for the data page, and a write count indication for the data page.

14. The method of claim 12, wherein the work memory is a volatile memory.

15. A data management method for a flash storage device including flash memory and a work memory, the method comprising:
upon power-up of the flash storage device, creating a cold list table storing a cold value for a data page stored in the flash memory, creating a compression data table storing compression rate information for the data page, and storing access information for the data page;
in response to a received garbage collection request, detecting the data page as cold data stored in the flash memory with reference to the cold list table and collecting the data page in the work memory;
compressing the data page to generate a compressed data page; and thereafter,
storing the compressed data page in the flash memory.

16. The method of claim 15, further comprising:
after collecting the data page in the work memory, invalidating the data page in the flash memory.

17. The method of claim 16, further comprising:
determining whether all pages of a block including the invalidated data page are invalidated; and
if all pages of a block including the invalidated data page are invalidated, erasing the block.

18. The method of claim 15, further comprising:
storing the cold list table in the work memory; and
updating the cold list table upon receiving a read operation directed to data page.

19. The method of claim 15, wherein the cold value is determined using at least one of time stamp information, age information, and read count information for the data page.

20. The method of claim 15, further comprising:
creating a compression data table storing compression rate information for the compressed data page.
